(19) United States
(12) Patent Application Publication
(10) Pub. No.: US 2012/0314688 A1
(43) Pub. Date: Dec. 13, 2012

(54) METHOD FOR ROUTING TRAFFIC WITHIN A NETWORK AND A NETWORK

(75) Inventors: Tarik Taleb, Heidelberg (DE); Stefan Schmid, Heidelberg (DE)

(73) Assignee: NEC EUROPE LTD., HEIDELBERG (DE)

(21) Appl. No.: 13/577,002

(22) PCT Filed: Feb. 7, 2011
(86) PCT No.: PCT/EP2011/000548

§ 371 Date: Aug. 3, 2012

(30) Foreign Application Priority Data
Feb. 5, 2010 (EP) 10001210.3

(51) Int. Cl. H04W 36/22

(52) U.S. Cl. 370/331

(57) ABSTRACT

A method for routing traffic within a network for allowing an efficient offloading of LIPA/SIPTO traffic from the core network even upon handoff of a UE to a new cell, wherein the network includes a core network and a LIPA/SIPTO (Local IP Access/Selected IP Traffic Offload) enabled network, wherein traffic between a UE (User Equipment) and the LIPA/SIPTO enabled network—a so called LIPA/SIPTO traffic—is broken out at a local breakout point and wherein a mobility support for ongoing broken out LIPA/SIPTO traffic will be provided by an MMF (Mobility Management Function) for realizing a continuation of the LIPA/SIPTO traffic upon a handoff of the UE from one cell to another cell. The continuation of the LIPA/SIPTO traffic will be performed by a forwarding mechanism providing direct LIPA/SIPTO traffic between local breakout points of different cells. A network for carrying out the method is also described.

The present invention relates to a method for routing traffic within a network, wherein the network is comprising a core network and a LIPA/SIPTO (Local IP Access/Selected IP Traffic Offload) enabled network, wherein traffic between a UE (User Equipment) and the LIPA/SIPTO enabled network—a so called LIPA/SIPTO traffic—is broken out at a local breakout point and wherein a mobility support for ongoing broken out LIPA/SIPTO traffic will be provided by an MMF (Mobility Management Function) for realizing a continuation of the LIPA/SIPTO traffic upon a handoff of the UE from one cell to another cell.

Further, the present invention relates to a network, wherein the network is comprising a core network and a LIPA/SIPTO (Local IP Access/Selected IP Traffic Offload) enabled network, wherein traffic between a UE (User Equipment) and the LIPA/SIPTO enabled network—a so called LIPA/SIPTO traffic—is broken out at a local breakout point and wherein a mobility support for ongoing broken out LIPA/SIPTO traffic will be provided by an MMF (Mobility Management Function) for realizing a continuation of the LIPA/SIPTO traffic upon a handoff of the UE from one cell to another cell.

LIPA and SIPTO are important features within modern network technology. In the present document the short form “LIPA/SIPTO” is frequently used. This will mean “LIPA and/or SIPTO”, namely a Local IP Access (LIPA) from a UE into a network and/or the Selected IP Traffic Offload (SIPTO) with regard to a core network. More details with regard to LIPA and SIPTO are obtainable from TS Group Services and System Aspects; Local IP Access and Selected IP Traffic Offload (Rel. 10), 3GPP TR 23.829.

According to already known methods and networks the traffic between a UE and the LIPA/SIPTO enabled network, the LIPA/SIPTO traffic, is broken out at a local breakout point. For realizing such a local breakout point many solutions introduce a novel entity, called “L-GW” (Local Gateway).

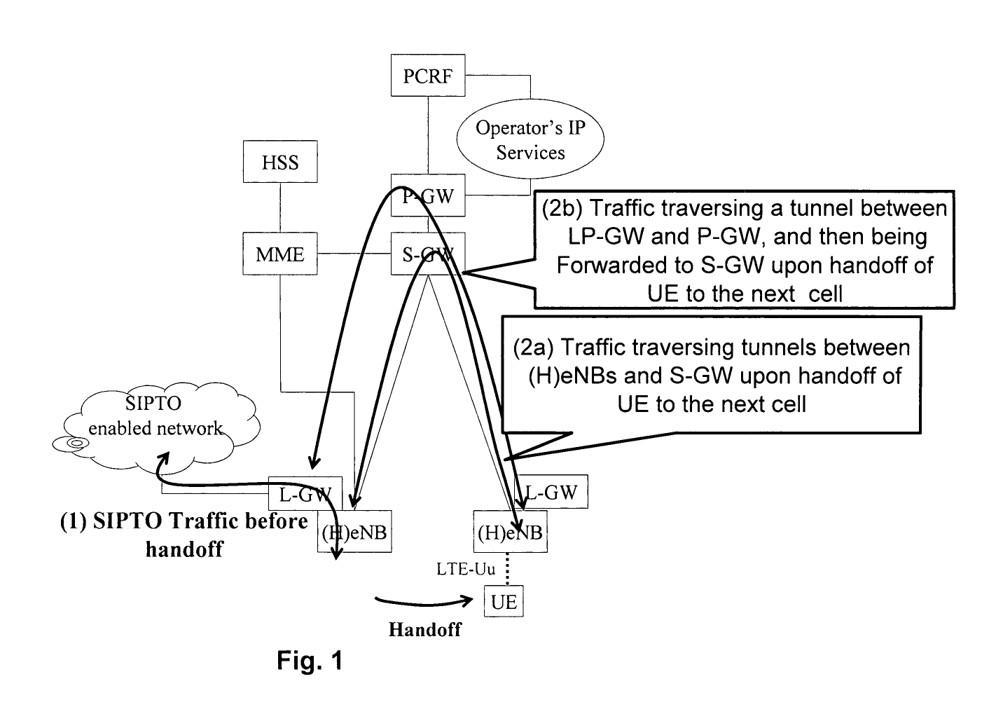

FIG. 1 illustrates an example on how the mobility will be supported within the framework of SIPTO solutions devised so far. Upon handoff of a UE to a new cell, two main options can be envisioned:
SIPTO traffic is forwarded from source (H)eNB ((Home) evolved Node B) to target (H)eNB via tunnels built within S-GW
SIPTO traffic is forwarded from L-GW at source (H)eNB to P-GW (Packet Gateway) via a tunnel between L-GW and P-GW, and then to target (H)eNB via S-GW (Serving Gateway).

Clearly, the two above mentioned options are not achieving the main goals of SIPTO, which is offloading traffic—as locally as possible - from the core network, and result in wasting CN's (Core Network) scarce resources, represented by P/S-GWs.

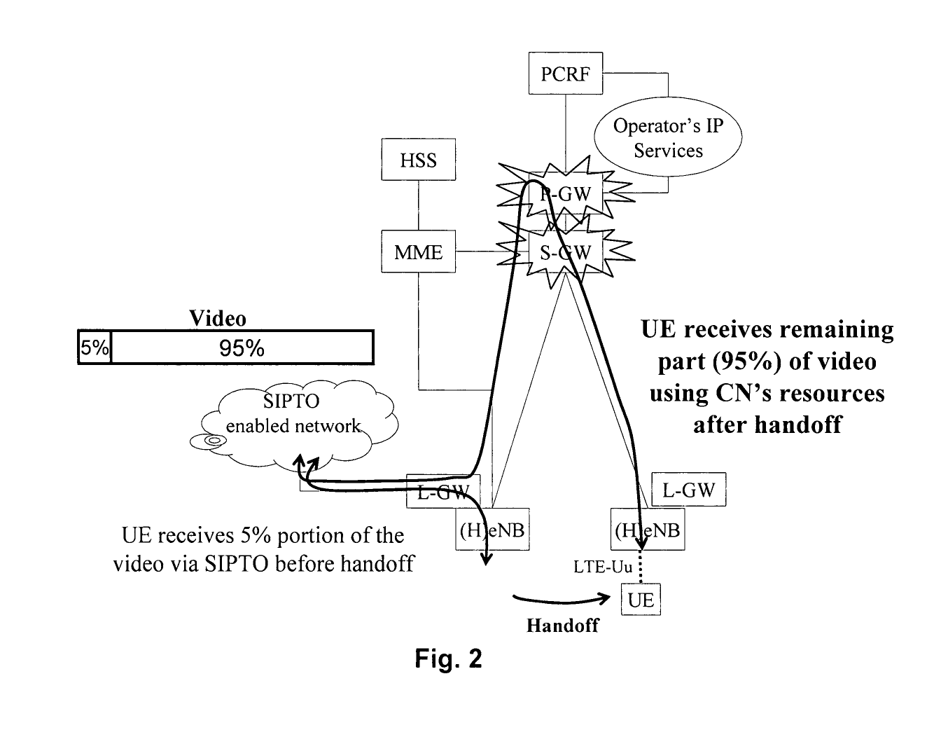

The problem becomes further significant if we consider, for instance, the example scenario as depicted in FIG. 2. In this scenario, a UE initiates a video stream when residing in the source (H)eNB, after receiving only 5% portion of the video via source (H)eNB and locally broken out at L-GW, the UE handoffs to the next cell and continues receiving the remaining 95% of the video using the CN's resources.

It is an object of the present invention to improve and further develop a method for routing traffic within a network and an according network for allowing an efficient offloading of LIPA/SIPTO traffic from the core network even upon handoff of a UE to a new cell.

In accordance with the invention, the aforementioned object is accomplished by a method comprising the features of claim 1 and by a network comprising the features of claim 23.

According to claim 1 the method is characterized in that the continuation of the LIPA/SIPTO traffic will be performed by a forwarding mechanism providing direct LIPA/SIPTO traffic between local breakout points of different cells.

According to claim 23 the network is characterized by a forwarding mechanism for performing the continuation of the LIPA/SIPTO traffic, wherein the forwarding mechanism is providing direct LIPA/SIPTO traffic between local breakout points of different cells.

According to the invention it has been recognized that it is possible to provide direct LIPA/SIPTO traffic between local breakout points of different cells by a suitable forwarding mechanism. On the basis of such a forwarding mechanism the continuation of the LIPA/SIPTO traffic is possible without an indirect way via the core network. Thus, a very efficient offloading of LIPA/SIPTO traffic from the core network is possible even upon handoff of a UE to a new cell. In other words, LIPA/SIPTO traffic is kept always nearby the UE or an access network of the UE, even after the motion of the UE. The invention ensures that LIPA/SIPTO traffic is offloaded nearby the UE or an access network of the UE and further ensures support of service continuity.

Within a preferred embodiment of the present invention, the forwarding mechanism could be realized by an IP-in-IP tunnelling or by a source routing. However, the invention is not limited to one of the above mentioned mechanisms. Generally, any mechanism that enables forwarding of data between two entities could be used for realizing service continuity.

With regard to a very effective and simple continuation of the LIPA/SIPTO traffic each local breakout point could be realized by an L-GW.

Depending on the individual situation the local breakout point or the L-GW could be realized by an LP-GW (Local PDN (Packet Data Network) Gateway), by an L-GGSN (Local Gateway GPRS (General Packet Radio Service) Support Node) or by a TOF (Traffic Offload Function).

With regard to a very efficient offloading of LIPA/SIPTO traffic each local breakout point or L-GW could be located nearby—in a standalone fashion—and/or could be assigned to or could be collocated with an (H)(e)NB ((Home)(evolved)Node B). This will mean that each local breakout point or L-GW could be located nearby and/or could be assigned to or could be collocated with an HeNB, eNB, HNB or NB depending on the individual network type, LTE (Long Term Evolution), UMTS (Universal Mobile Telecommunications System) or GSM (Global System for Mobile Communications), for example. The invention could be used within all such network types.

Within another preferred embodiment the MMF could be an MME (Mobility Management Entity). However, depending on the individual situation the MMF could be realized separately from a MME at a suitable location within the network.

For providing a reliable service continuity the MMF—by maintaining relevant data—could keep track of UEs with ongoing LIPA/SIPTO traffic or sessions. Alternatively or additionally the MMF—by maintaining relevant data—could keep track of the UE's corresponding original L-GWs, from which the UE has initiated the LIPA/SIPTO traffic or session. Thus, the MMF could provide a suitable management of the continuation of LIPA/SIPTO traffic upon a handoff of the UE from one cell to another cell.

Within a further preferred embodiment at least one L-GW—by maintaining relevant data—could keep track of UEs with ongoing LIPA/SIPTO traffic traversing the L-GW and/or of the L-GWs associated with (H)(e)NBs, to which UEs are currently connecting to, and/or of said (H)(e)NBs, to which UEs are currently connecting to. Alternatively or additionally an L-GW—by maintaining relevant data—could keep track of preferably each LIPA/SIPTO session comprising broken out LIPA/SIPTO traffic, of its corresponding UE and/or of its corresponding original L-GW, from which the corresponding UE has initiated the LIPA/SIPTO session. By each of the above mentioned different functionalities of an L-GW continuation of LIPA/SIPTO traffic could be promoted.

With regard to a very simple method for routing traffic the MMF and/or the L-GW could maintain the relevant data in the form of a table. With regard to a reliable routing of the LIPA/SIPTO traffic the table could be constantly updated, preferably by using a signalling message to/from the MMF.

If the (H)(e)NB is not LIPA/SIPTO enabled or does not have an L-GW assigned to it, a (H)(e)NB could be associated with a P-GW of the core network within the table. Thus, a table could comprise actual and useful routing data, even in the case of a (H)(e)NB which is not LIPA/SIPTO enabled.

Further, with regard to a reliable routing of LIPA/SIPTO traffic, information regarding broken out LIPA/SIPTO traffic or LIPA/SIPTO session or LIPA/SIPTO sessions could be communicated to the L-GW of or associated with a target (H)(e)NB during establishment of the forwarding mechanism providing direct LIPA/SIPTO traffic between the local breakout points.

Within a further preferred embodiment at least one L-GW could inform the MMF about the end of a LIPA/SIPTO traffic or LIPA/SIPTO session or LIPA/SIPTO sessions of a particular UE by a signalling message. On the basis of such an end information the table within the MMF and/or L-GW could be kept actual with regard to no longer existing LIPA/SIPTO traffic or sessions. Within a concrete embodiment of the invention the signalling message could be a LIPA/SIPTO end marker signalling message.

The above signalling message could further be used for providing a charging related info collector unit with LIPA/SIPTO accounting information comprising data required for charging purposes. By such a procedure, a simple charging could be realized.

The data required for charging purposes could comprise a packet count and/or data volume. In any case a reliable charging could be provided.

Within a very simple embodiment of the invention for each UE the LIPA/SIPTO accounting information could be aggregated at the charging related info collector unit. Within a further preferred and very simple embodiment, the charging related info collector unit could be located within the MMF.

For providing a simple and reliable charging LIPA/SIPTO accounting information could be sent preferably directly from an L-GW to a PCEF (Policy Control Enforcement Function) within the core network.

If an UE initially receives LIPA/SIPTO traffic via a not LIPA/SIPTO enabled (H)(e)NB and then later connects to a LIPA/SIPTO enabled (H)(e)NB, a P-GW of the core network could be enabled for offload of LIPA/SIPTO traffic a the P-GW. Thus, the case of a (H)(e)NB which is not LIPA/SIPTO enabled could be comprised by the invention in a very simple way.

The present invention is very useful for all kinds of mobile networks such as GSM, UMTS or LTE, for example.

On the basis of the present invention LIPA/SIPTO traffic can always be kept nearby an access network, wherein such an access network could be realized by (H)(e)NBs.

The invention ensures that LIPA/SIPTO traffic can always be offloaded nearby an access network and efficiently supports service continuity.

Further, the usage of CN's resources is optimized via route optimization of LIPA/SIPTO traffic. Further, on the basis of the present invention distributed charging of LIPA/SIPTO traffic is supported.

There are several ways how to design and further develop the teaching of the present invention in an advantageous way. To this end it is to be referred to the patent claims subordinate to patent claim 1 on the one hand and to the following explanation of preferred examples of the invention, illustrated by the drawing on the other hand. In connection with the explanation of the preferred embodiments of the invention by the aid of the drawing, generally preferred embodiments and further developments of the teaching will we explained. In the drawings

FIG. 1 is illustrating the conventional mobility support within the framework of conventional SIPTO solutions,

FIG. 2 is illustrating an example scenario showing the significant limitation of conventional SIPTO solutions,

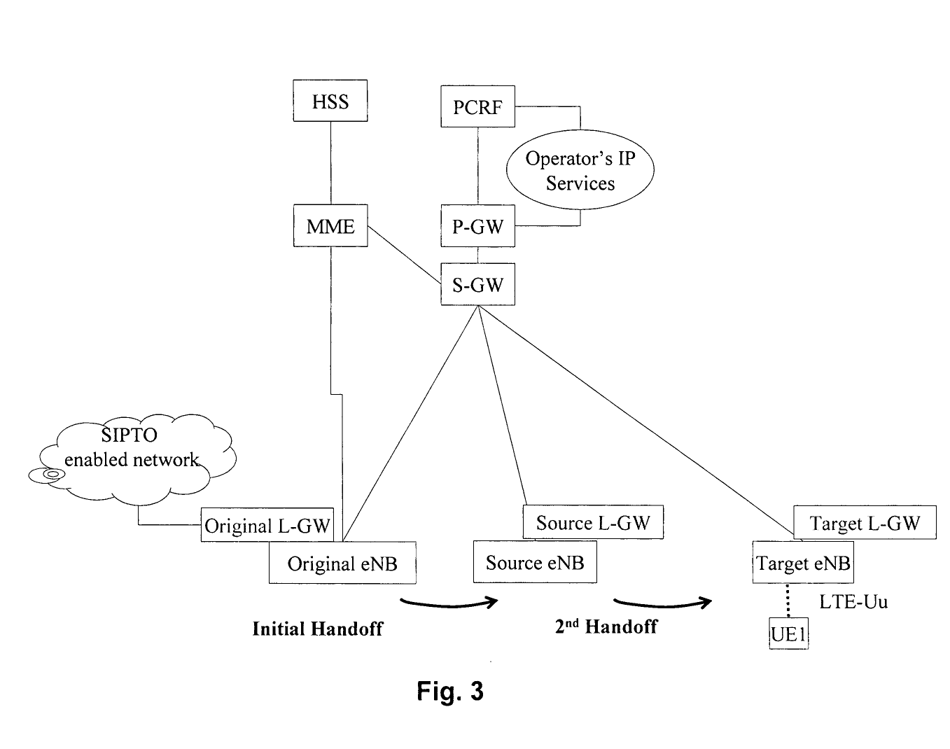

FIG. 3 is illustrating some definitions for illustrating the invention,

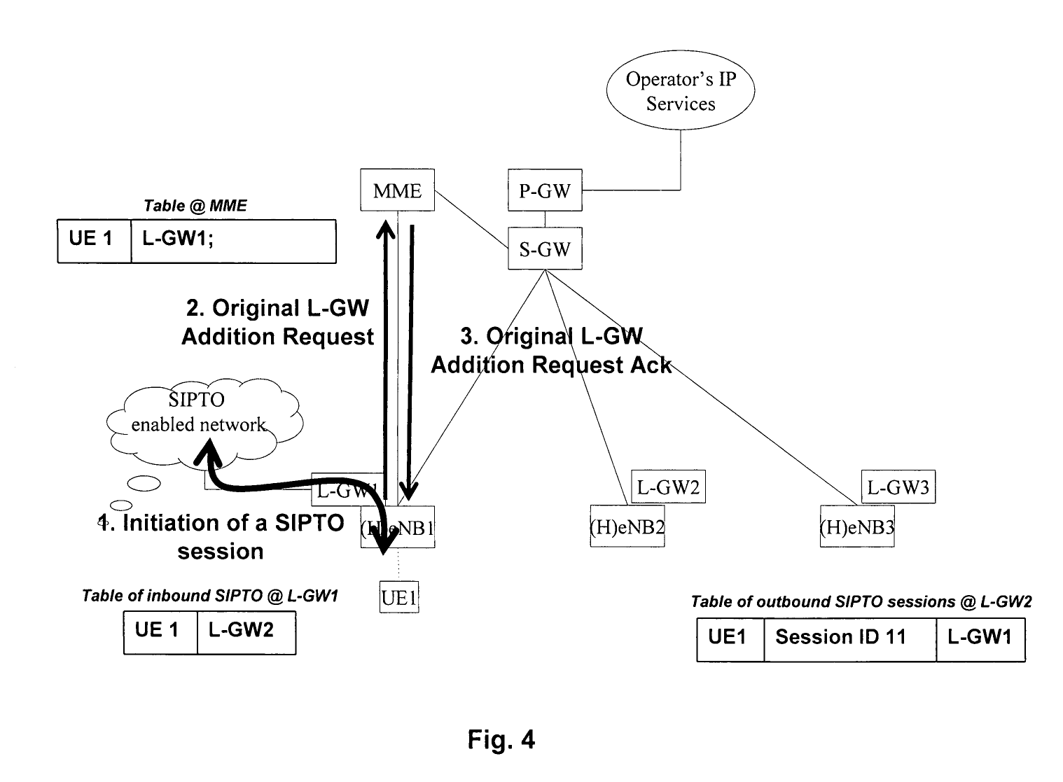

FIG. 4 is illustrating the initiation of a SIPTO session according to a preferred embodiment of the invention,

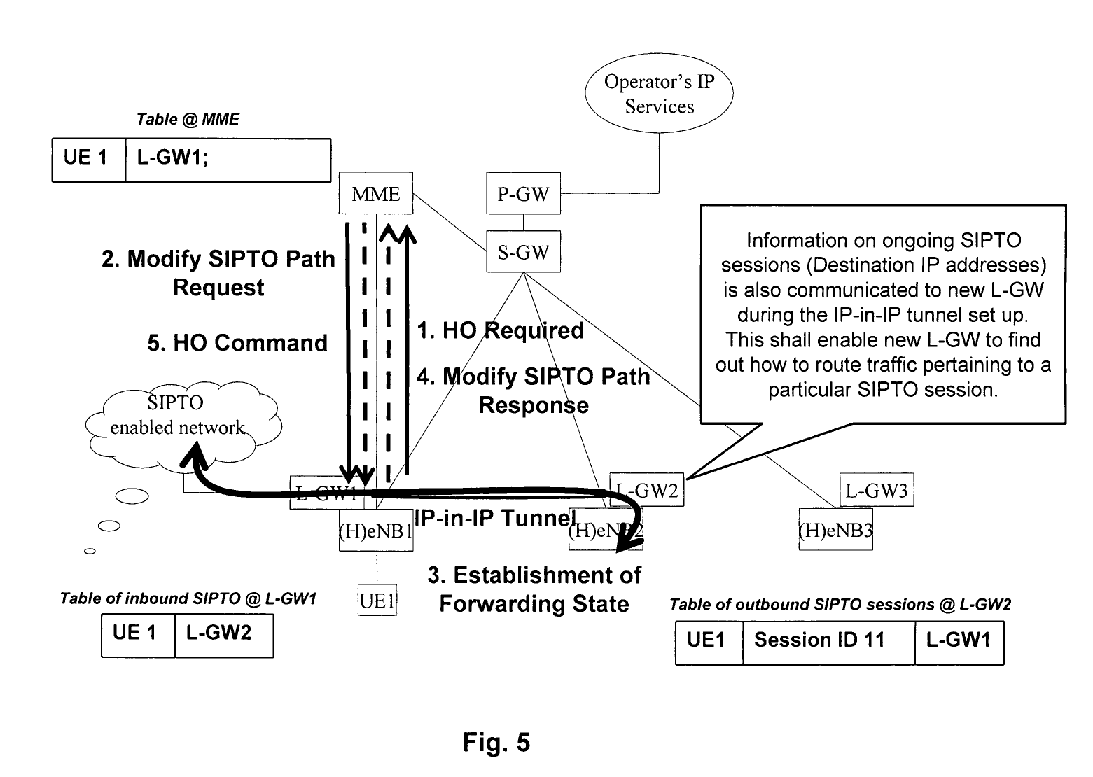

FIG. 5 is illustrating an initial handoff procedure according to the preferred embodiment,

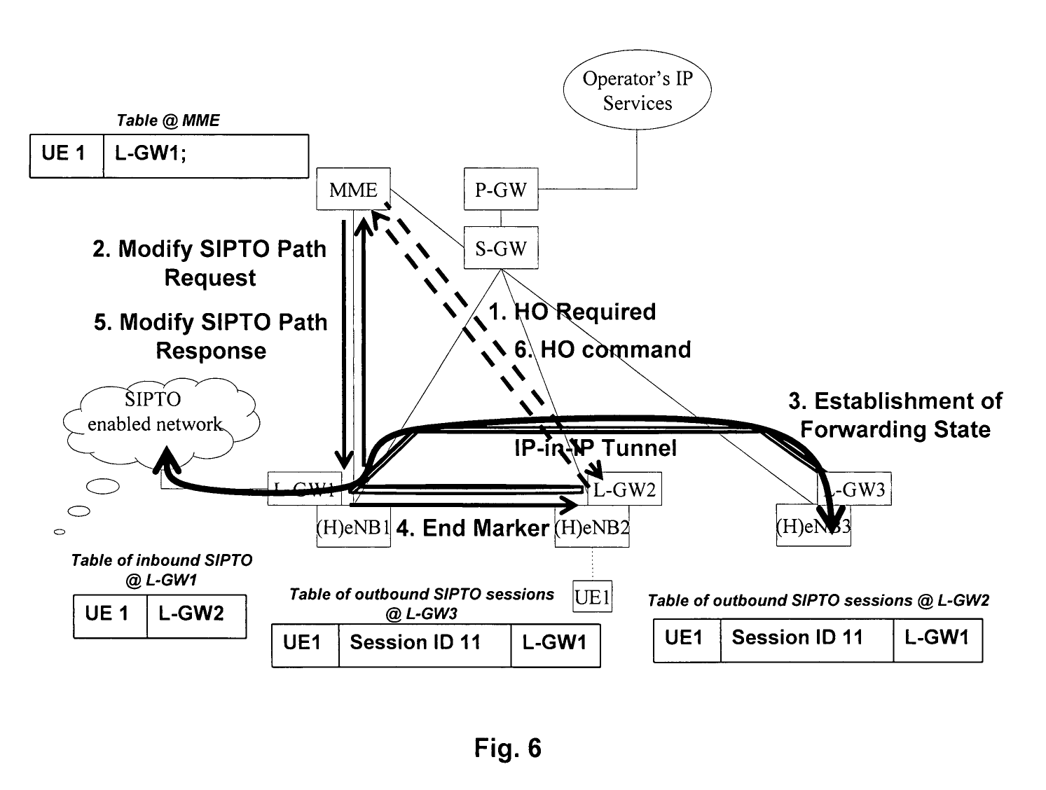

FIG. 6 is illustrating a subsequent handoff according to the preferred embodiment,

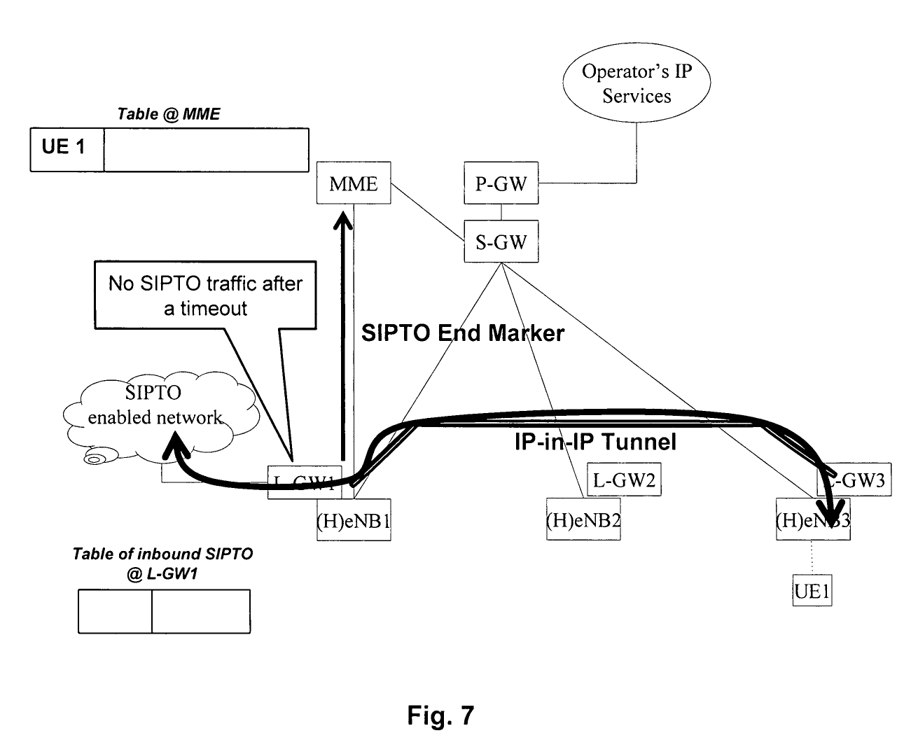

FIG. 7 is illustrating a SIPTO traffic termination at a particular original L-GW,

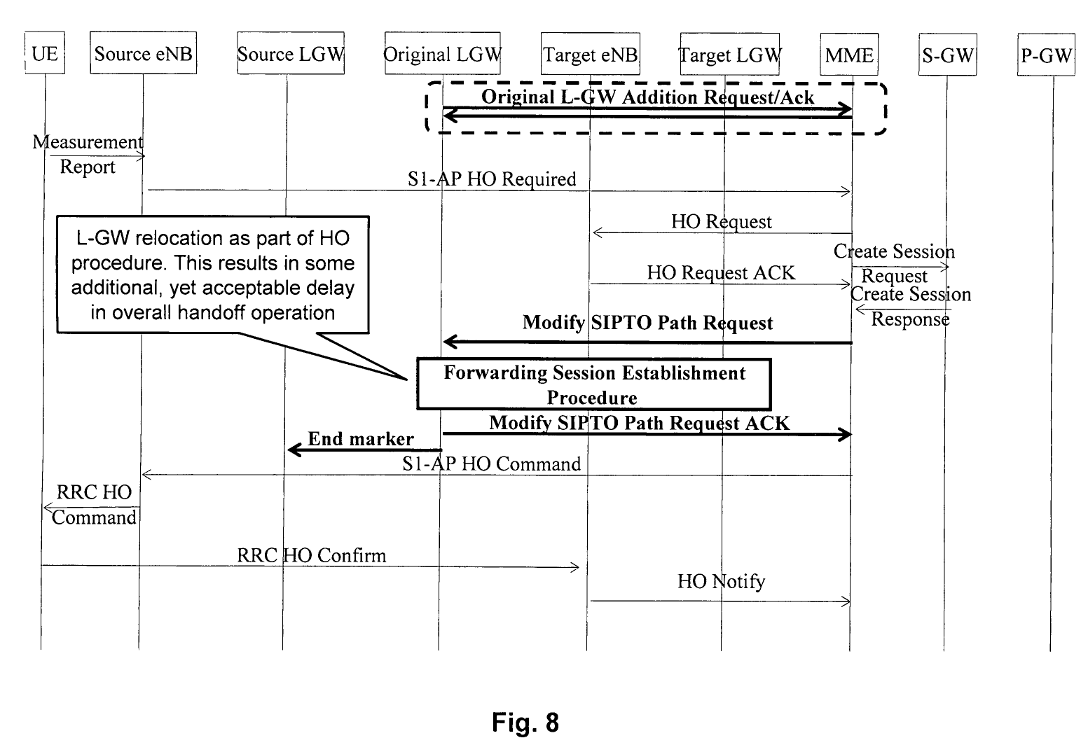

FIG. 8 is illustrating within a table the L-GW relocation as part of the handoff procedure according to the invention,

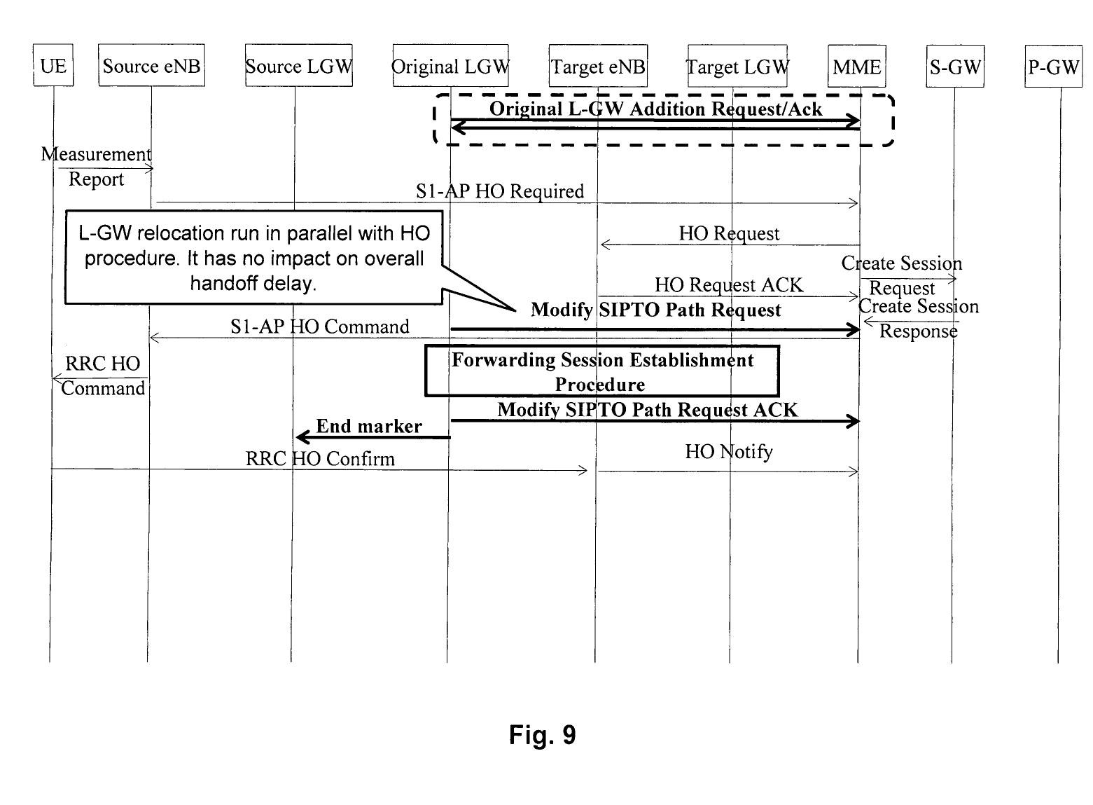

FIG. 9 is illustrating a L-GW relocation run in parallel with the handoff procedure according to the invention and

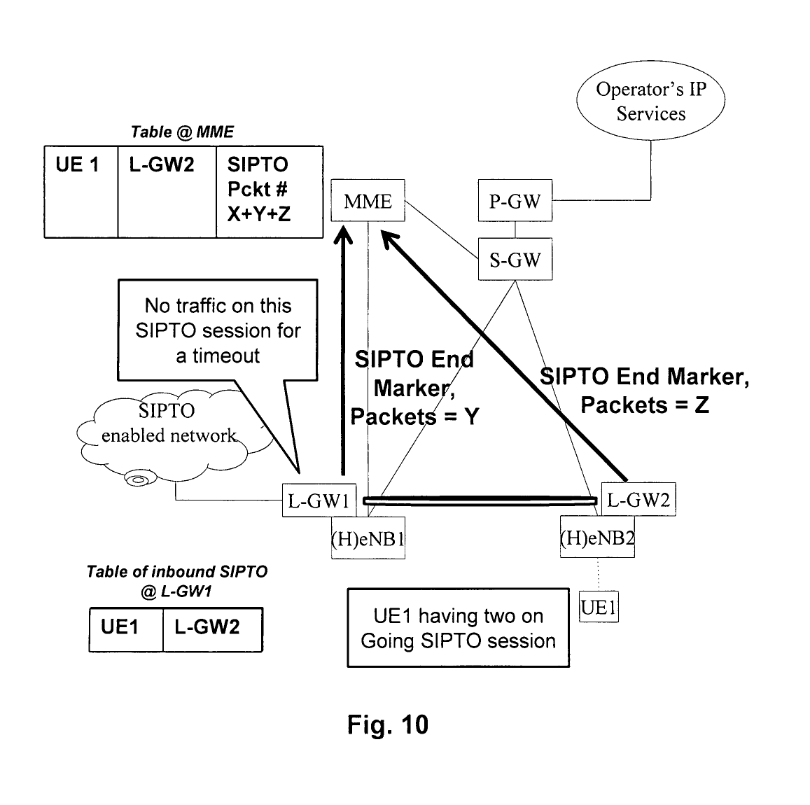

FIG. 10 is illustrating the use of a SIPTO end marker for charging purposes according to the invention.

Within the following description of preferred embodiments of the invention the focus is directed on EPS (Evolved Packet System) but the invention can be equally applied to GPRS. In this case, SGSN (Serving GPRS Support Node) would map on to S-GW and MME and GGSN (Gateway GPRS Support Node) would map on to P-GW. Within the scope of the claimed invention L-GW can be LP-GW, L-GGSN or TOF.

FIG. 3 is illustrating some definitions which are useful for understanding the following description. As within FIG. 2, L-GWs are placed nearby (H)(e)NBs. The definitions are as follows:
Original L-GW (of a UE): is the L-GW that the UE was connecting to when it initiated a particular “on-going” SIPTO session or a number of “on-going” SIPTO sessions. Note that a UE may have more than one original L-GWs; if a UE initiates a SIPTO session while being connected to an (H)(e)NB1 associated with an L-GW1, then moves to a different area, connects to an (H)(e)NB2 associated with an L-GW2 and initiates another SIPTO session, and then moves again to another (H)(e)NB3 and the two SIPTO sessions are still active, both L-GW1 and L-GW2 are original L-GWs for the UE.
Source L-GW: The L-GW associated with the (H)(e)NB a UE is currently connecting to.
Target L-GW: The L-GW associated with the target (H)(e)NB a UE is soon going to handoff (HO) to.
Initial handoff (for a particular SIPTO session): The first handoff a UE performs from the original L-GW to another L-GW while the corresponding SIPTO session is still active.
2^{nd} or later handoff (for a particular SIPTO session): handoff that comes after the initial one while the corresponding SITPO session is still active.

An L-GW according to a preferred embodiment of the invention has the following main functionalities or a set of them:
Source NATing (Network Address Translation)
Charging
SIPTO traffic handling
Ability to perform forwarding session establishment procedure, e.g., simple IP-in-IP tunnelling, source routing, etc, with counterpart L-GWs at neighbouring or distant (H)(e)NBs, direct tunnelling with (H)(e)NBs, and when necessary with core P-GW or S-GW.
Ability to interfere with MME using a specific interference (or via own-(H)(e)NB)

Maintenance of a per UE table as follows:
Table of in bound SIPTO sessions:
   When a UE initiates a SIPTO session or a number of SIPTO sessions via the L-GW of a particular (H)(e)NB and later on handoffs to another (H)(e)NB, the L-GW keeps track of which (H)(e)NB and/or L-GW the UE is currently connected to. This tracking operation is carried out while there is SIPTO traffic, destined to the UE, traversing the L-GW. The L-GW maintains, e.g., in the form of a table, UEs with ongoing SIPTO traffic and the IP addresses of L-GWs of (H)(e)NB they are currently connected with. This table is constantly updated using signalling messages from MME, as will be detailed later. If an L-GW does not receive any SIPTO traffic for a particular UE within a predefined timeout and that UE is no longer connected to the L-GW, the UE is simply removed from the table of the L-GW. If a (H)(e)NB is not LIPA/SIPTO enabled, i.e. does not have an L-GW collocated with it, it is simply associated with the CN's P-GW in the table.
Table of outbound SIPTO sessions:
   When a UE with some ongoing SIPTO sessions handoffs to a particular (H)(e)NB, the L-GW associated with the particular (H)(e)NB maintains a table where it corresponds each ongoing SIPTO session with its original L-GW. This table is used by the L-GW to find out how to route traffic pertaining to a particular SIPTO session. Information on ongoing SIPTO sessions, e.g., destination IP addresses, is communicated to new L-GWs during the forwarding session establishment procedure, e.g., IP-in-IP tunnel set up, etc.

Within the description of the preferred embodiment the MMF is realized by a MME. Such a MME is comprising the following important features:
In the form of a table, MME maintains a list of original L-GWs for each UE with on-going SIPTO sessions.
When a UE performs handoff to a target (H)(e)NB and MME receives a “Path Switch Request” from the target (H)(e)NB or alternatively, “handover required” message from source (H)(e)NB), MME sends a “Modify SIPTO Path Request” to all original L-GWs of the UE which are available from the above mentioned table. In response, original L-GWs send a “Modify SIPTO Path Response.”
For charging purposes only, a “Charging Related Info Collector” unit may be incorporated in MME.

FIGS. 4 and 5 are showing schematically the initiation of a SIPTO session and an according initial handoff of a UE1 from an L-GW1 to an L-GW2. During such a procedure different signalling messages are sent between an MME and an L-GW. The most important signalling messages are explained in the following listing together with a SIPTO end marker message and end marker message which are important for the subsequent handoff of an UE and the SIPTO traffic termination at a particular original L-GW as explained within FIGS. 6 and 7:
Original L-GW Addition Request: When a UE initiates a SIPTO session through a particular L-GW, the L-GW sends this message to the MME requesting to be added to the list of original L-GWs of the UE.
Original L-GW Addition Request Ack: Reply or acknowledgement from the MME in response to the Original L-GW Addition Request
SIPTO End Marker: When a particular UE is no longer connected with an L-GW and there is no on-going SIPTO traffic for the UE coming through the L-GW, the L-GW immediately notifies MME of the same by sending “SIPTO End Marker”, so the L-GW will be removed from the list of original L-GWs of the UE. Optionally, SIPTO end marker messages may contain information about SIPTO packet count (required for charging purposes). For each UE, the SIPTO packet count will be aggregated at the “Charging Related Info Collector” unit located in MME. As an alternative option, this information on SIPTO packet count can be sent from L-GWs directly to PCEF (Policy Control Enforcement Function) of core P-GW.
End-Marker (from Source L-GW to Target L-GW): This message is signalled in case of 2^{nd} or later handoff occurrence and indicates the end of SIPTO traffic destined for a particular UE from a source L-GW to the Target L-GW.
Modify SIPTO Path Request: Message from MME to Original L-GWs of a particular UE indicating that the UE has changed its point of attachment to the network and thus corresponding SIPTO traffic should be forwarded to the L-GW of the target (H)(e)NB.
Modify SIPTO Path Response: This signalling message is used to acknowledge the reception of the “Modify SIPTO Path Request” from MME and successful “forwarding session establishment procedure”, i.e., between original L-GW and target L-GWs.

FIGS. 8 and 9 are illustrating within a listing an L-GW relocation as part of handover or handoff (HO) procedure and an L-GW relocation run in parallel with handover procedure, respectively, according to different preferred embodiments of the invention.

FIG. 10 is illustrating schematically the use of a SIPTO end marker for charging purposes. Within this embodiment the SIPTO end marker is used for transmitting a count of transmitted packets within an L-GW.

Within FIGS. 4 to 7 and 10 is illustrated the content of information tables at the MME and the L-GWs. The association of the respective table with the respective entity is illustrated by the sign “@”.

It has to be noted that the explained embodiments of the invention refer to SIPTO traffic only. However, the invention and its embodiments are also applicable to LIPA traffic.

Further, when a UE initially receives SIPTO traffic via a non-SIPTO capable (e)NB and then later connects to a SIPTO capable (e)NB, the following enhancements to P-GW are required to enable the offload of SIPTO traffic at P-GW.
Ability to perform forwarding session establishment procedure, e.g., simple IP-in-IP tunnelling, source routing, etc.
Ability to distinguish traffic which is subject to SIPTO and traffic which is to be serviced via operator network
Prior knowledge on SIPTO capabilities of (H)(e)NBs. Otherwise, MME may have this knowledge (i.e., which (e)NB is SIPTO enabled and which one is not) and communicate this information to P-GWs using S11/S5 interfaces.

The invented solution optimizes LIPA/SIPTO traffic routes and supports service continuity. An advantage of invention compared to current state of the art is the efficient traffic offloading along with efficient mobility support.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for routing traffic within a network, wherein the network comprises a core network and a LIPA/SIPTO (Local IP Access/Selected IP Traffic Offload) enabled network, wherein traffic between a UE (User Equipment) and the LIPA/SIPTO enabled network—a so called LIPA/SIPTO traffic—is broken out at a local breakout point and wherein a mobility support for ongoing broken out LIPA/SIPTO traffic will be provided by an MMF (Mobility Management Function) for realizing a continuation of the LIPA/SIPTO traffic upon a handoff of the UE from one cell to another cell,
characterized in that the continuation of the LIPA/SIPTO traffic will be performed by a forwarding mechanism providing direct LIPA/SIPTO traffic between local breakout points of different cells.

2. A method according to claim 1, wherein the forwarding mechanism is realized by an IP-in-IP tunneling or by a source routing.

3. A method according to claim 1, wherein each local breakout point is realized by an L-GW (Local Gateway).

4. A method according to claim 1, wherein the local breakout point or the L-GW is realized by an LP-GW (Local PDN (Packet Data Network) Gateway), L-GGSN (Local Gateway GPRS (General Packet Radio Service) Support Node) or TOF (Traffic Offload Function).

5. A method according to claim 1, wherein each local breakout point or L-GW is located nearby and/or is assigned to an (H)(e)NB ((Home)(evolved)Node B), or is collocated with an (H)(e)NB.

6. A method according to claim 1, wherein the MMF is a MME (Mobility Management Entity).

7. A method according to claim 1, wherein the MMF—by maintaining relevant data—keeps track of UEs with ongoing LIPA/SIPTO traffic or sessions.

8. A method according to claim 3, wherein the MMF—by maintaining relevant data—keeps track of the UE's corresponding original L-GWs, from which the UE has initiated the LIPA/SIPTO traffic or session.

9. A method according to claim 3, wherein at least one L-GW—by maintaining relevant data—keeps track of UEs with ongoing LIPA/SIPTO traffic traversing the L-GW and/or of the L-GWs associated with (H) (e)NBs, to which UEs are currently connecting to, and/or of said (H) (e)NBs, to which UEs are currently connecting to.

10. A method according to claim 3, wherein an L-GW—by maintaining relevant data—keeps track of preferably each LIPA/SIPTO session comprising broken out LIPA/SIPTO traffic, of its corresponding UE and/or of its corresponding original L-GW, from which the corresponding UE has initiated the LIPA/SIPTO session.

11. A method according to claim 7, wherein the MMF and/or the L-GW is maintaining the relevant data in the form of a table.

12. A method according to claim 11, wherein the table will be constantly updated, preferably by using a signalling message to/from the MMF.

13. A method according to claim 11, wherein within the table a (H)(e)NB is associated with a P-GW of the core network, if the (H) (e)NB is not LIPA/SIPTO enabled or does not have an L-GW assigned to it.

14. A method according to claim 3, wherein information regarding broken out LIPA/SIPTO traffic or LIPA/SIPTO session(s) will be communicated to the L-GW of or associated with a target (H)(e)NB during establishment of the forwarding mechanism providing direct LIPA/SIPTO traffic between the local breakout points.

15. A method according to claim 3, wherein at least one L-GW informs the MMF about the end of a LIPA/SIPTO traffic or LIPA/SIPTO session or LIPA/SIPTO sessions of a particular UE by a signalling message.

16. A method according to claim 15, wherein the signalling message is a LIPA/SIPTO end marker signalling message.

17. A method according to claim 15, wherein the signalling message will be used for providing a charging related info collector unit with LIPA/SIPTO accounting information comprising data required for charging purposes.

18. A method according to claim 17, wherein the data comprises a packet count and/or data volume.

19. A method according to claim 17, wherein for each UE the LIPA/SIPTO accounting information will be aggregated at the charging related info collector unit.

20. A method according to claim 17, wherein the charging related info collector unit is located within the MMF.

21. A method according to claim 3, wherein LIPA/SIPTO accounting information will be sent preferably directly from an L-GW to a PCEF (Policy Control Enforcement Function) within the core network.

22. A method according to claim 1, wherein a P-GW of the core network will be enabled for offload of LIPA/SIPTO traffic at the P-GW, if an UE initially receives LIPA/SIPTO traffic via a not LIPA/SIPTO enabled (H)(e)NB and then later connects to a LIPA/SIPTO enabled (H) (e)NB.

23. A Network, preferably for carrying out the method for routing traffic within a network according to claim 1, wherein the network comprises a core network and a LIPA/SIPTO (Local IP Access/Selected IP Traffic Offload) enabled network, wherein traffic between a UE (User Equipment) and the LIPA/SIPTO enabled network—a so called LIPA/SIPTO traffic—is broken out at a local breakout point and wherein a mobility support for ongoing broken out LIPA/SIPTO traffic will be provided by an MMF (Mobility Management Function) for realizing a continuation of the LIPA/SIPTO traffic upon a handoff of the UE from one cell to another cell,
characterized by a forwarding mechanism for performing the continuation of the LIPA/SIPTO traffic, wherein the forwarding mechanism provides direct LIPA/SIPTO traffic between local breakout points of different cells.
